(19) United States
(12) Patent Application Publication
(10) Pub. No.: US 2006/0053984 A1
(43) Pub. Date: Mar. 16, 2006

(54) Wrench for use on english and metric sized workpieces

(76) Inventor: James Patrick Walsh, Cohoes, NY (US)

Correspondence Address: James Patrick Walsh, 59 Canvass Street, Cohoes, NY, 12047, US

(21) Appl. No.: 10/939,326

(22) Filed: Sep. 13, 2004

(51) Int. Cl. B25B 13/00; B25B 13/02; B25B 13/06

(52) U.S. Cl. 81/125.1; 81/119; 81/121.1

(57) ABSTRACT

The English and Metric Wrench (M & I Wrench) is a design with inch on one end of the wrench and metric on the other end. The English and Metric Wrench will be made of forged steel and carbon which will be case hardened and polished. In conditions where you do not want sparks, the English and Metric Wrench will be made out of a brass alloy.

The invention generally relates to hand tools used in rotating workpieces. More particularly, the invention relates to a single wrench capable of rotating a standard English sized workpiece as well as a standard metric sized workpiece.

### BACKGROUND OF THE INVENTION

Hand tools, such as wrenches, are commonly used in the manufacture and maintenance of mechanical equipment. The wrench is commonly used to apply torque to a workpiece, such as bolts, screws, nuts, pipes, fasteners and the like, in order to tighten or loosen the workpiece. The majority of countries around the world have adopted the metric system as the national standard or specification of measurement and, thus, workpieces are commonly incrementally sized by millimeter. However, contrary to the majority of the other industrialized countries, the United States still utilizes the English or British measuring system. Thus, domestic workpieces are typically incrementally sized by a fraction of an inch, such as ¼, ⅜, 7/16, ½, 9/16, ⅝, ¾, and etc.

Although many of the respective English metric measurements may be close to one and another in actual size, such as ¼ inch and 6 mm, use of a wrench on nuts and bolts differing by such amounts is between the wrench and workpiece. Therefore, in light of the need for a precise fit between the wrench head and the workpiece, wrench heads sized to fit standard English workpieces often cannot be used for a similar standard metric workpiece despite being relatively close in actual size.

In light of the growing cooperation among domestic and foreign corporations, parts may be assembled or manufactured in a country using workpieces sized in accord with one measuring system and then these same parts may be assembled or incorporated into a machine in a country using a different measuring system. Therefore, it is common that a single product, such as an automobile, will have standard size workpieces conforming to both English and metric measurments. Therefore, it is highly desirable to have a single wrench capable of tightening or loosening both English sized and metric sized fittings or workpieces.

To date, this need has been fulfilled either by having two separate sets of wrenches, one English sized and one metric, or by wrenches having a single head designed to accommodate multiple sized workpieces. For example, Blachy (U.S. Pat. No. 4,574,665) teaches a ratchet wrench in which the interior of the wrench head has a linearly grooved beveled surface at the entry end of the cams as opposed to conical-shaped cams. Similarly, Ruzicka et al. Teaches a wrench capable of accommodating workpieces of two or more nominal sizes by the design and location of various concave surfaces on the interior section of the wrench head. However, such wrenches incorporated complicated designs which add significantly to the cost of the tool. In addition, use of separate sets of English and metric sized tools does not aid in the selection of the proper sized wrench when unfamiliar with one of the two measuring systems.

### DESCRIPTION OF THE DRAWINGS

FIG. 1 is a top view of an open faced square wrench of the present invention.

FIG. 2 is a top of a M & I wrench showing an open end on one end and box end on the opposing end with metric on the open end and English on the box end.

FIG. 3 is a top view of a M & I wrench showing English on the open end and metric on the box end.

FIG. 4 is a top view of a M & I wrench showing a box end wrench on both sides, with metric on one end and English on the other end.

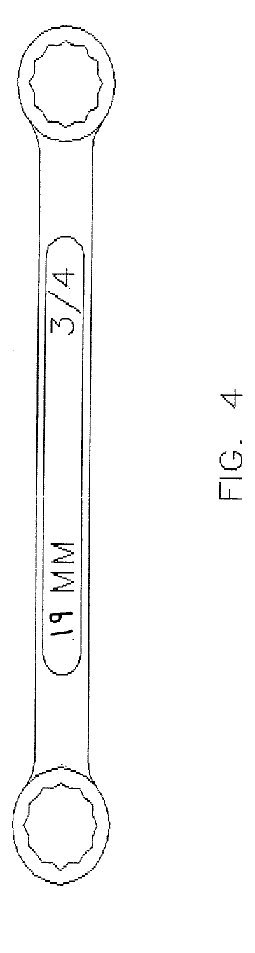

### DESCRIPTION OF THE INVENTION

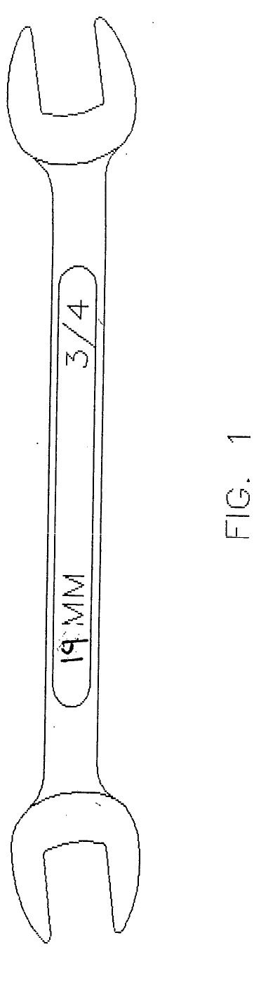

As may be seen as shown in FIG. 1 a two-headed wrench having a handle 10 with first and second opposed ends 12 and 13; a first wrench head 14 integrally formed on one end of the handle 10 and sized to fit a standard English sized workpiece; and a second wrench head 15 integrally formed on the opposed end of the handle sized to fit a standard metric sized workpiece.

The wrench preferably a single integrated unit and may be manufactured by means well known in the art. The wrench may comprise materials commonly used in the fabrication of such hand tools, examples being stainless steel and other hard and durable composites and polymeric materials. The handle of the wrench may further have grooves therein or coatings, such as rubber, in order to improve a workers grip on the wrench. In addition, the handle may likewise have markings 18 adjacent each of the opposed heads indicating the size and measuring system of the workpiece the wrench head is intended to be applied to.

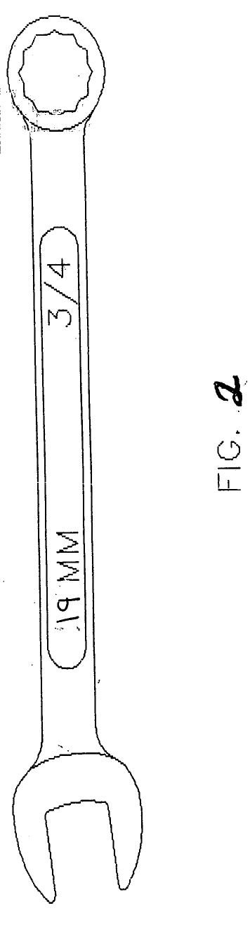

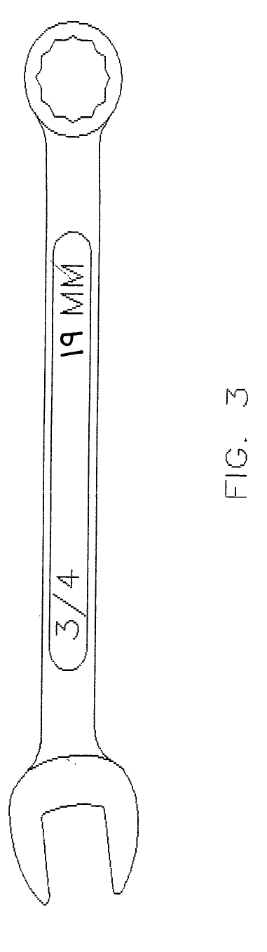

The wrench heads may be open faced or closed faced, including square, hexagonal, or polygonal configurations. The opposed wrench heads on a single wrench may be of the same design, such as shown in FIGS. 1 and 2 FIG. 1 shows opposed open faced wrench heads 14 and 15, the first wrench head sized to fit a ¾ inch workpiece and the opposing open faced wrench head sized to fit a 19 mm sized workpiece. As shown in reference to FIG. 2, the wrench shows box end wrench heads 16 and 17 respectively sized to fit ¾ inch and 1 g mm workpieces. In addition, the opposed wrench heads may be of a different design, such as shown in reference to FIG. 3, one end having a open faced wrench head and the opposed end having a closed face or box end wrench head.

Preferably the opposed English and metric sized wrench heads are sized to fit standard workpieces close to one another, in actual size such as:

¼ inch and 6 mm, 5/16 inch and 8 mm, ⅜ inch and 10 mm
7/16 inch and 11 mm, ½ inch and 13 mm, 9/16 inch and 14 mm
⅝ inch and 16 mm, 11/16 inch and 18 mm, ¾ inch and 19 mm
13/16 inch and 21 mm, ⅞ inch and 22 mm,

This configuration would allow a mechanic or manufacturer, upon seeing a particular fastener or workpiece to assess its approximate size without the need to determine whether it is a English or metric sized work piece, and obtain a single wrench to rotate the workpiece avoiding the need for multiple wrenches. In addition, this allows a mechanic who is unfamiliar with one of the two measuring systems to obtain the appropriate wrench with greater ease. For example, a mechanic in the United States, unfamiliar with the metric standards, may see a workpiece and immediately know its approximate U.S. standard size yet not know its approximate metric size. By having a wrench with the English sized head and a similarly sized metric head the mechanic can more easily obtain the proper wrench for metric sized workpieces.

Although the preferred embodiments of the invention have been disclosed herewith, it will be apparent to those skilled in the art the modifications may be made to the basic design without departing from the general concepts that have been disclosed herein. Therefore, the specific embodiments shown herein are not intended to be limiting, and the breadth of the invention should be understood to be measured by the scope of the attached claims.

What is claimed:

1. A two ended wrench comprising:
A handle having opposed first and second ends;
A first wrench end integrally formed on the first wrench end being sized to fit a standard English sized work piece comprised of a single work piece whereas Bella's consist of interchangeable pieces.
A second wrench end integrally formed on said second end of the handle, said Second wrench end being sized to fit a standard metric sized work piece comprised of a single work piece whereas Bella's consist of interchangeable pieces.

2. The wrench of claim 1 wherein said first and second wrench ends are open faced wrench ends comprised of a single work piece whereas Bella's consist of interchangeable pieces.

3. The wrench of claim 1 wherein said first and second wrench ends are closed wrench ends comprised of a single work piece whereas Bella's consist of interchangeable pieces.

4. The wrench of claim 2 wherein said first wrench end is an open faced wrench end and said second wrench end a closed wrench end comprised of a single work piece whereas Bella's consist of interchangeable pieces.

5. The wrench of claim 1 wherein the wrench has a marking adjacent one of the two ends identifying the standard size work piece it is intended to fit, comprised of a single work piece whereas Bella's consist of interchangeable pieces.

6. The wrench of claim 1 wherein the handle has markings, thereon adjacent the first and second wrench ends, identifying the standard size work piece it is intended to fit, is comprised of a single work piece whereas Bella's consist of interchangeable pieces.
